(19) United States
(12) Patent Application Publication
(10) Pub. No.: US 2017/0263919 A1
(43) Pub. Date: Sep. 14, 2017

(54) LITHIUM ELECTRODES FOR LITHIUM-SULPHUR BATTERIES

(71) Applicants: RHODIA OPERATIONS, Paris (FR); COMMISSARIAT A L' ENERGIE ATOMIQUE ET AUX ENERGIES ALTERNATIVES, Paris (FR)

(72) Inventors: Silvia Rita PETRICCI, Bresso (IT); Luca MERLO, Montorfano (IT); Céline BARCHASZ, Fontaine (FR)

(21) Appl. No.: 15/529,830

(22) PCT Filed: Nov. 20, 2015
(86) PCT No.: PCT/EP2015/077288

§ 371 Date: May 25, 2017

(30) Foreign Application Priority Data
Nov. 25, 2014 (EP) 14306878.1

(51) Int. Cl. H01M 4/137; H01M 4/58; H01M 4/134; C08J 5/22; H01M 2/16; H01M 10/42; H01M 4/38; H01M 10/0525; H01M 4/1395

(52) U.S. Cl. CPC H01M 4/137; H01M 10/0525; H01M 4/58; H01M 4/134; H01M 4/1395; H01M 2/16; H01M 10/42; H01M 4/38; C08J 5/2237; C08J 2327/12

(57) ABSTRACT

The present invention pertains to a process for manufacturing a film, said process comprising: (i) providing a composition [composition (C)] comprising, preferably consisting of: —at least one fluoropolymer [polymer (F)] comprising recurring units derived from at least one fluorinated monomer comprising a —SO 3 M functional group, wherein M is an alkaline metal [monomer (FM)] and—a liquid medium [medium (L)] comprising at least 50% by weight, based on the total weight of said medium (L), of at least one alkyl carbonate; (ii) processing the composition (C) provided in step (i) into a film; and (iii) drying the film provided in step (ii). The present invention further pertains to use of said film in a process for manufacturing a lithium electrode and to use of said lithium electrode in a process for manufacturing a lithium-sulphur battery.

### CROSS-REFERENCE TO RELATED APPLICATION

This application claims priority to European application No. 14306878.1 filed on Nov. 25, 2014, the whole content of this application being incorporated herein by reference for all purposes.

### TECHNICAL FIELD

The present invention pertains to a process for manufacturing a film, to use of said film in a process for manufacturing a lithium electrode and to use of said lithium electrode in a process for manufacturing a lithium-sulphur battery.

### BACKGROUND ART

Sulphur is abundant, cheap and nontoxic. Rechargeable lithium-sulphur (Li—S) batteries are expected to deliver a theoretical energy density up to 2600 Wh/kg suitable for electric vehicles with a charge autonomy of 500 km or more. However, the commercialization of these batteries is impeded by unsolved technical problems related to the insulating nature of sulphur and to the high solubility of lithium polysulphides in the electrolyte. Different strategies have been proposed to improve the electrochemical performance of the Li—S battery by special designs of the cathode structure, electrolyte composition and anode protection.

One of the main drawbacks related to Li—S cells is the limited cycle stability caused by irreversible processes leading to continuous loss of capacity. Particularly, the reduction of long chained lithium polysulphides on the lithium surface and the subsequent re-oxidation at the cathode, referred as polysulphide shuttle mechanism, leads to parasitic self-discharge and reduced charge efficiency. Moreover, insoluble and insulating short chained lithium polysulphides are formed on both cathode and anode surfaces.

Different attempts have been investigated to encapsulate polysulphides in the cathode.

Another promising approach is to protect the lithium surface from reaction with polysulphides by a protective coating layer formed by a cross-linking reaction of a curable monomer in the presence of a liquid electrolyte and a photoinitiator. See, for instance, PARK, Jung-ki, et al. Electrochemical performance of lithium-sulphur batteries with protected Li anodes. Journal of Power Sources. 2003, vol.119-121, p.964-972.

Also, another approach is to promote the in situ formation of a stable solid electrolyte interface (SEI) layer by application of LiNO₃ electrolyte additive. Unfortunately, LiNO₃ is consumed during SEI formation on lithium and therefore has no enduring effect on charge efficiency due to formation of lithium dendrites upon cycling. It is also reported that LiNO₃ decomposes in Li—S cells at voltages below 1.6 V vs. Li/Li⁺.

Moreover, it is possible to transform the separator into an ion selective barrier being impermeable to polysulphides but permeable to lithium ions in order to suppress the shuttle mechanism.

Free standing membranes based on NAFION® PFSA comprising —SO₃Li functional groups suitable for use as polymer electrolytes in Li—S batteries have been disclosed, for instance, in JIN, Zhaoqing, et al. Application of lithiated NAFION® PFSA ionomer film as functional separator for lithium-sulphur cells. Journal of Power Sources. 2012, vol.218, p.163-167.

Further, CELGARD® 2500 polypropylene separators coated with a Li-NAFION® PFSA film having a thickness of about 1-5 μm suitable for use as cation-selective membranes for Li—S batteries have been disclosed, for instance, in ALTHUES, H., et al. Reduced polysulphide shuttle in lithium-sulphur batteries using NAFION® PFSA-based separators. Journal of Power Sources. 2014, vol.251, p.417-422.

### SUMMARY OF INVENTION

In a first instance, the present invention pertains to a process for manufacturing a film, said process comprising:

(i) providing a composition (C) comprising, preferably consisting of:
at least one fluoropolymer [polymer (F)] comprising recurring units derived from at least one fluorinated monomer comprising a —SO₃M functional group, wherein M is an alkaline metal [monomer (FM)] and
a liquid medium [medium (L)] comprising at least 50% by weight, based on the total weight of said medium (L), of at least one alkyl carbonate;

(ii) processing the composition (C) provided in step (i) into a film; and

(iii) drying the film provided in step (ii).

The composition (C) of the invention is particularly suitable for use in a process for manufacturing a film according to the invention.

It has been found that the composition (C) of the invention can be easily processed into a film thereby advantageously providing a continuous and homogeneous film.

In a second instance, the present invention pertains to a film obtainable by the process of the invention.

The film of the invention typically comprises, preferably consists of, at least one layer comprising at least one fluoropolymer [polymer (F)] comprising recurring units derived from at least one fluorinated monomer comprising a —SO₃M functional group, wherein M is an alkaline metal [monomer (FM)].

The film of the invention is advantageously a dense film.

For the purpose of the present invention, the term “dense” is intended to denote a homogeneous film having a completely uniform structure free from voids, pores or holes of finite dimensions.

A dense film thus distinguishes from a porous film, wherein the term “porous” is intended to denote a film containing a plurality of voids, pores or holes of finite dimensions.

In a third instance, the present invention pertains to an electrode comprising a current collector, said current collector comprising:
at least one lithium layer, and
adhered to said at least one lithium layer, a film comprising, preferably consisting of, at least one layer comprising at least one fluoropolymer [polymer (F)] comprising recurring units derived from at least one fluorinated monomer comprising a —SO₃M functional group, wherein M is an alkaline metal [monomer (FM)].

The current collector of the electrode of the invention typically comprises:
at least one metal layer,
adhered to said at least one metal layer, at least one lithium layer, and
adhered to said at least one lithium layer, a film comprising, preferably consisting of, at least one layer comprising at least one fluoropolymer [polymer (F)] comprising recurring units derived from at least one fluorinated monomer comprising a —SO₃M functional group, wherein M is an alkaline metal [monomer (FM)].

The metal layer of the current collector of the electrode of the invention preferably consists of a metal selected from the group consisting of copper and stainless steel.

The metal layer of the current collector of the electrode of the invention is typically in the form of either a metal foil or a metal grid.

In a fourth instance, the present invention thus pertains to a process for manufacturing the electrode of the invention.

According to a first embodiment of the invention, the process for manufacturing an electrode comprises:

(i-1) providing a current collector comprising at least one lithium layer;

(ii-1) providing a composition (C) as defined above;

(iii-1) applying the composition (C) provided in step (ii-1) onto the at least one lithium layer of the current collector provided in step (i-1) thereby providing a film; and

(iv-1) drying the film provided in step (iii-1).

The electrode obtainable by the process according to this first embodiment of the invention is advantageously the electrode of the invention.

Under step (i-1) of the process according to this first embodiment of the invention, the current collector typically comprises:
at least one metal layer, and
adhered to said at least one metal layer, at least one lithium layer.

Under step (i-1) of the process according to this first embodiment of the invention, the metal layer of the current collector, if any, preferably consists of a metal selected from the group consisting of copper and stainless steel.

Under step (i-1) of the process according to this first embodiment of the invention, the metal layer of the current collector, if any, is typically in the form of either a metal foil or a metal grid.

According to a second embodiment of the invention, the process for manufacturing an electrode comprises:

(i-2) providing a current collector comprising at least one lithium layer;

(ii-2) providing a film, said film being obtainable by a process comprising:

(i) providing a composition (C) as defined above;

(ii) processing the composition (C) provided in step (i) into a film; and

(iii) drying the film provided in step (ii); and

(iii-2) applying the film provided in step (ii-2) onto the at least one lithium layer of the current collector provided in step (i-2).

The electrode obtainable by the process according to this second embodiment of the invention is advantageously the electrode of the invention.

Under step (i-2) of the process according to this second embodiment of the invention, the current collector typically comprises:
at least one metal layer, and
adhered to said at least one metal layer, at least one lithium layer.

Under step (i-2) of the process according to this second embodiment of the invention, the metal layer of the current collector, if any, preferably consists of a metal selected from the group consisting of copper and stainless steel.

Under step (i-2) of the process according to this second embodiment of the invention, the metal layer of the current collector, if any, is typically in the form of either a metal foil or a metal grid.

According to a third embodiment of the invention, the process for manufacturing an electrode comprises:

(i-3) providing a film, said film being obtainable by a process comprising:

(i) providing a composition (C) as defined above;

(ii) processing the composition (C) provided in step (i) into a film; and

(iii) drying the film provided in step (ii);

(ii-3) depositing at least one lithium layer onto the film provided in step (i-3); and

(iii-3) optionally, applying at least one metal layer onto the at least one lithium layer provided in step (ii-3).

The electrode obtainable by the process according to this third embodiment of the invention is advantageously the electrode of the invention.

Under step (iii-3) of the process according to this third embodiment of the invention, if any, the metal layer preferably consists of a metal selected from the group consisting of copper and stainless steel.

Under step (iii-3) of the process according to this third embodiment of the invention, if any, the metal layer is typically in the form of either a metal foil or a metal grid.

In a fifth instance, the present invention pertains to a secondary battery comprising:

(a) an electrode comprising a current collector, said current collector comprising:
at least one lithium layer, and
adhered to said at least one lithium layer, a film comprising, preferably consisting of, at least one layer comprising at least one fluoropolymer [polymer (F)] comprising recurring units derived from at least one fluorinated monomer comprising a —SO₃M functional group, wherein M is an alkaline metal [monomer (FM)],

(b) a positive electrode, and

(c) a separator.

The electrode (a) of the secondary battery of the invention is advantageously the electrode of the invention.

The electrode (a) of the secondary battery of the invention typically operates as a negative electrode in the secondary battery of the invention.

The positive electrode (b) of the secondary battery of the invention typically comprises a current collector.

For the purpose of the present invention, the term “secondary” is intended to denote a rechargeable battery which needs an external electrical source to recharge it. A battery typically undergoes an electrochemical process in an electrochemical cell wherein electrons flow from a negative electrode to a positive electrode during either charge cycles or discharge cycles.

For the purpose of the present invention, the term “negative electrode” is intended to denote the anode of an electrochemical cell where oxidation takes place.

For the purpose of the present invention, the term “positive electrode” is intended to denote the cathode of an electrochemical cell where reduction takes place.

For the purpose of the present invention, the term “current collector” is intended to denote an electrically conducting substrate allowing electrons to flow during either charge cycles or discharge cycles.

The secondary battery of the invention is preferably a lithium-sulphur (Li—S) battery comprising:

(a) an electrode comprising a current collector, said current collector comprising:
at least one lithium layer, and
adhered to said at least one lithium layer, a film comprising, preferably consisting of, at least one layer comprising at least one fluoropolymer [polymer (F)] comprising recurring units derived from at least one fluorinated monomer comprising a —SO₃M functional group, wherein M is an alkaline metal [monomer (FM)],

(b) a positive electrode comprising a current collector, said current collector comprising at least one sulphur layer, and

(c) a separator.

The electrode (a) of the Li—S battery of the invention is advantageously the electrode of the invention.

The electrode (a) of the Li—S battery of the invention typically operates as a negative electrode in the Li—S battery of the invention.

It has been surprisingly found that the Li—S battery of the invention advantageously exhibits absent or reduced polysulphide shuttle mechanism, while maintaining good or increased capacity values, as compared to conventional Li—S batteries.

The Applicant thinks, without this limiting the scope of the invention, that this is due to the inherent structure of the electrode of the invention, said electrode being obtainable from the composition (C) according to the process of the invention.

The current collector of the positive electrode (b) of the Li—S battery of the invention typically comprises:
at least one carbon layer, and
adhered to said at least one carbon layer, at least one sulphur layer.

The current collector of the positive electrode (b) of the Li—S battery of the invention may further comprise at least one metal layer.

The current collector of the positive electrode (b) of the Li—S battery of the invention preferably comprises:
at least one metal layer,
adhered to said at least one metal layer, at least one carbon layer and,
adhered to said at least one carbon layer, at least one sulphur layer.

The sulphur layer of the positive electrode (b) of the Li—S battery of the invention is typically made from either cyclic octasulphur (S₈) or its cyclic S₁₂ allotrope.

The carbon layer of the positive electrode (b) of the Li—S battery of the invention, if any, is typically made from a carbonaceous material, preferably from a carbonaceous material selected from the group consisting of carbon black, carbon nanotubes, activated carbon, graphite powder, graphite fiber and metal powders or fibers such as nickel and aluminium powders or fibers.

The metal layer of the current collector of the positive electrode (b) of the Li—S battery of the invention, if any, preferably consists of a metal selected from the group consisting of aluminium, nickel and stainless steel.

The metal layer of the current collector of the positive electrode (b) of the Li—S battery of the invention, if any, is typically in the form of either a metal foil or a metal grid or a metal foam.

Should the metal layer of the current collector of the positive electrode (b) of the Li—S battery of the invention consist of aluminium, it is usually in the form of either a metal foil or a metal grid.

Should the metal layer of the current collector of the positive electrode (b) of the Li—S battery of the invention consist of nickel, it is usually in the form of either a metal foil or a metal grid or a metal foam.

The composition (C) of the invention is advantageously in the form of a solution.

For the purpose of the present invention, the term “solution” is intended to denote a uniformly dispersed mixture of at least one polymer (F), typically referred to as solute, in the medium (L), typically referred to as solvent. The term “solvent” is used herein in its usual meaning, that is to say that it refers to a substance capable of dissolving a solute. It is common practice to refer to a solution when the resulting mixture is clear and no phase separation is visible in the system. Phase separation is taken to be the point, often referred to as “cloud point”, at which the solution becomes turbid or cloudy due to the formation of polymer aggregates or at which the solution turns into a gel.

The medium (L) typically consists essentially of at least one alkyl carbonate.

The alkyl carbonate is typically selected from the group consisting of linear alkyl carbonates of formula (I) and cyclic alkylene carbonates of formula (II):

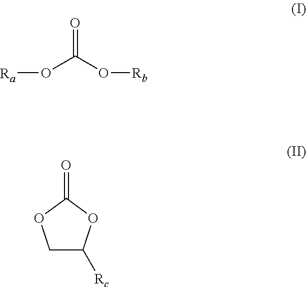

wherein:

Rₐ and R_{b}, equal to or different from each other, are independently C₁-C₆ alkyl groups, preferably C₁-C₄ alkyl groups, more preferably C₁-C₂ alkyl groups, and

R_{c} is a hydrogen atom or a C₁-C₆ alkyl group, preferably a hydrogen atom or a C₁-C₄ alkyl group, more preferably a hydrogen atom or a C₁-C₂ alkyl group.

The medium (L) may comprise at least 50% by weight, based on the total weight of said medium (L), of at least one linear alkyl carbonate of formula (I) as defined above and/or at least one cyclic alkylene carbonate of formula (II) as defined above.

The alkyl carbonate is preferably selected from the group consisting of linear alkyl carbonates of formula (I) such as dimethyl carbonate or ethyl methyl carbonate and cyclic alkylene carbonates of formula (II) such as ethylene carbonate or propylene carbonate.

The medium (L) may further comprise at least one alkyl ether.

Should the medium (L) further comprise at least one alkyl ether, said medium (L) typically comprises, preferably consists essentially of:
at least 50% by weight, based on the total weight of said medium (L), of at least one alkyl carbonate, and
at most 50% by weight, based on the total weight of said medium (L), of at least one alkyl ether.

The alkyl ether is typically selected from the group consisting of linear alkyl ethers and cyclic alkylene ethers.

The alkyl ether is preferably selected from the group consisting of linear alkyl ethers such as 1,2-dimethoxyethane or tetraethylene glycol dimethyl ether and cyclic alkylene ethers such as 1,3-dioxolane or tetrahydrofurane.

The medium (L) is advantageously free from water.

The medium (L) is also advantageously free from organic solvents selected from the group consisting of N-methyl-2-pyrrolidone, dimethyl sulphoxide, N,N-dimethyl acetamide, N,N-diethyl acetamide, dimethyl formamide and diethyl formamide.

For the purpose of the present invention, the term “fluoropolymer” is intended to denote a polymer comprising a backbone comprising recurring units derived from at least fluorinated monomer [monomer (F)].

The term “fluorinated monomer [monomer (F)]” is hereby intended to denote an ethylenically unsaturated monomer comprising at least one fluorine atom and, optionally, at least one hydrogen atom.

The term “at least one fluorinated monomer” is understood to mean that the polymer (F) may comprise recurring units derived from one or more than one fluorinated monomers. In the rest of the text, the expression “ fluorinated monomers” is understood, for the purposes of the present invention, both in the plural and the singular, that is to say that they denote both one or more than one fluorinated monomers as defined above.

The polymer (F) typically comprises recurring units deriving from:
at least one fluorinated monomer comprising at least one —SO₃M functional group, wherein M is an alkaline metal [monomer (FM)], and
at least one fluorinated monomer [monomer (F)].

Non limiting examples of suitable monomers (FM) are selected from the group consisting of:
sulfonyl halide fluoroolefins of formula CF₂═CF(CF₂)ₚSO₃M, wherein p is an integer comprised between 0 and 10, preferably between 1 and 6, more preferably p is equal to 2 or 3, and M is an alkaline metal;
sulfonyl halide fluorovinylethers of formula CF₂═CF—O—(CF₂)ₘSO₃M, wherein m is an integer comprised between 1 and 10, preferably between 1 and 6, more preferably between 2 and 4, even more preferably m is equal to 2, and M is an alkaline metal;
sulfonyl halide fluoroalkoxyvinylethers of formula CF₂═CF—(OCF₂CF(R_{F1}))_{w}—O—CF₂(CF(R_{F2}))_{y}SO₃M, wherein w is an integer comprised between 0 and 2, RF₁ and RF₂, equal to or different from each other, are independently F, Cl or C₁-C₁₀ fluoroalkyl groups, optionally substituted with one or more ether oxygen atoms, y is an integer between 0 and 6, and M is an alkaline metal; preferably w is 1, RF₁ is —CF₃, y is 1 and RF₂ is F;
sulfonyl halide aromatic fluoroolefins of formula CF₂═CF—Ar—SO₃M, wherein Ar is a C₅-C₁₅ aromatic or heteroaromatic substituent and M is an alkaline metal.

For the purpose of the present invention, the term “alkaline metal” is intended to denote a metal selected from the group consisting of Li, Na, K, Rb and Cs. The alkaline metal is preferably selected from the group consisting of Li, Na and K.

The monomer (FM) is preferably selected from the group consisting of fluorovinylethers of formula CF₂═CF—O—(CF₂)ₘ—SO₃Li, wherein m is an integer comprised between 1 and 6, preferably between 2 and 4.

The monomer (FM) is more preferably CF₂═CF—OCF₂CF₂—SO₃Li.

Non limiting examples of suitable monomers (F) are selected from the group consisting of:
C₂-C₈ fluoroolefins, such as tetrafluoroethylene, pentafluoropropylene, hexafluoropropylene and hexafluoroisobutylene;
vinylidene fluoride;
C₂-C₈ chloro- and/or bromo- and/or iodo-fluoroolefins, such as chlorotrifluoroethylene and bromotrifluoroethylene;
fluoroalkylvinylethers of formula CF₂═CFOR_{f1}, wherein R_{f1} is a C₁-C₆ fluoroalkyl, e.g. —CF₃, —C₂F₅, —C₃F₇;
fluoro-oxyalkylvinylethers of formula CF₂═CFOR_{O1}, wherein R_{O1} is a C₁-C₁₂ fluoro-oxyalkyl group having one or more ether groups, e.g. perfluoro-2-propoxy-propyl group;
fluoroalkyl-methoxy-vinylethers of formula CF₂═CFOCF₂OR_{f2}, wherein R_{f2} is a C₁-C₆ fluoroalkyl group, e.g. —CF₃, —C₂F₅, —C₃F₇, or a C₁-C₆ fluorooxyalkyl group having one or more ether groups, e.g. —C₂F₅—O—CF₃;
fluorodioxoles of formula:

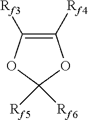

wherein each of R_{f3}, R_{f4}, R_{f5}, R_{f6}, equal to or different from each other, is independently a fluorine atom, a C₁-C₆ fluoroalkyl group, optionally comprising one or more ether oxygen atoms, e.g. —CF₃, —C₂F₅, —C₃F₇, —OCF₃, —OCF₂CF₂OCF₃.

The monomer (F) is preferably selected from the group consisting of:
C₂-C₅ fluoroolefins, preferably tetrafluoroethylene and/or hexafluoropropylene;
chloro- and/or bromo- and/or iodo-C₂-C₆ fluoroolefins, such as chlorotrifluoroethylene and/or bromotrifluoroethylene;
fluoroalkylvinylethers of formula CF₂═CFOR_{f1}, wherein R_{f1} is a C₁-C₆ fluoroalkyl group, e.g. —CF₃, —C₂F₅, —C₃F₇;
fluoro-oxyalkylvinylethers of formula CF₂═CFOR_{O1}, wherein R_{O1} is a C₁-C₁₂ fluorooxyalkyl group having one or more ether groups, e.g. perfluoro-2-propoxy-propyl group.

The monomer (F) is more preferably tetrafluoroethylene.

The polymer (F) preferably comprises recurring units deriving from:
at least one monomer (FM) selected from the group consisting of fluorovinylethers of formula CF₂═CF—O—(CF₂)ₘ—SO₃Li, wherein m is an integer between 1 and 6, preferably between 2 and 4, and
tetrafluoroethylene.

The equivalent weight of the polymer (F), when converted into its acid form, is advantageously less than 1000 g/eq, preferably less than 900 g/eq, more preferably less than 800 g/eq, even more preferably less than 700 g/eq. The equivalent weight of the polymer (F), when converted into its acid form, is advantageously at least 400 g/eq, preferably at least 450 g/eq, more preferably at least 500 g/eq.

The monomer (FM) is typically present in the polymer (F) in an amount such that the equivalent weight of the polymer (F), when converted into its acid form, is advantageously less than 1000 g/eq, preferably less than 900 g/eq, more preferably less than 800 g/eq, even more preferably less than 700 g/eq. The monomer (FM) is typically present in the polymer (F) in an amount such that the equivalent weight of the polymer (F), when converted into its acid form, is advantageously at least 400 g/eq, preferably at least 450 g/eq, more preferably at least 500 g/eq.

For the purpose of the present invention, the term “equivalent weight” is defined as the weight of the polymer (F) in acid form required to neutralize one equivalent of NaOH, wherein the term “acid form” means that all the functional groups of said polymer (F) are in —SO₃H form.

The polymer (F) is typically obtainable by any polymerization process known in the art.

The polymer (F) is preferably obtainable from a fluoropolymer comprising recurring units derived from a fluorinated monomer comprising a —SO₂X functional group, wherein X is a halogen atom, preferably X being a fluorine atom, by any polymerization process known in the art. Suitable processes for the preparation of such fluoropolymers are for instance those described in EP 1323751 A (SOLVAY SOLEXIS S.P.A.) Jul. 2, 2003 and EP 1172382 A (AUSIMONT S.P.A.) Jan. 16, 2002.

The composition (C) preferably comprises, more preferably consists of:
from 1% to 30% by weight, preferably from 1% to 20% by weight, based on the total weight of the composition (C), of at least one fluoropolymer [polymer (F)] comprising recurring units derived from at least one fluorinated monomer comprising a —SO₃M functional group, wherein M is an alkaline metal [monomer (FM)], and
from 70% to 99% by weight, preferably from 80% to 99% by weight, based on the total weight of the composition (C), of a liquid medium [medium (L)] comprising at least 50% by weight, based on the total weight of said medium (L), of at least one alkyl carbonate.

Under step (ii) of the process for manufacturing a film according to the invention, the composition (C) provided in step (i) is processed into a film typically by using any suitable techniques, preferably by tape casting, dip coating, spin coating or spray coating.

Under step (iii) of the process for manufacturing a film according to the invention, the film provided in step (ii) is dried typically at a temperature comprised between 25° C. and 200° C.

Under step (iii) of the process for manufacturing a film according to the invention, drying can be performed either under atmospheric pressure or under vacuum. Alternatively, drying can be performed under modified atmosphere, e.g. under an inert gas, typically exempt notably from moisture (water vapour content of less than 0.001% v/v). The drying temperature will be selected so as to effect removal by evaporation of the medium (L) from the film of the invention.

Under step (iii-1) of the process for manufacturing an electrode according to the first embodiment of the invention, the composition (C) provided in step (ii-1) is applied onto the at least one lithium layer of the current collector provided in step (i-1) typically by any suitable techniques such as spin coating, spray coating, drop coating, dip coating and doctor blade, preferably by doctor blade.

Under step (iv-1) of the process for manufacturing an electrode according to the first embodiment of the invention, the film provided in step (iii-1) is dried typically at a temperature comprised between 25° C. and 200° C.

Under step (iv-1) of the process for manufacturing an electrode according to the first embodiment of the invention, drying can be performed either under atmospheric pressure or under vacuum. Alternatively, drying can be performed under modified atmosphere, e.g. under an inert gas, typically exempt notably from moisture (water vapour content of less than 0.001% v/v). The drying temperature will be selected so as to effect removal by evaporation of the medium (L) from the electrode of the invention.

Under step (iii-2) of the process for manufacturing an electrode according to the second embodiment of the invention, the film provided in step (ii-2) is applied onto the at least one lithium layer of the current collector provided in step (i-2) typically by any suitable techniques such as lamination.

Lamination typically comprises stacking the layers thereby providing an assembly and, optionally, pressing the assembly so obtained at a temperature comprised between 20° C. and 120° C.

Under step (ii-3) of the process for manufacturing an electrode according to the third embodiment of the invention, at least one lithium layer is deposited onto the film provided in step (i-3) typically by any suitable techniques such as physical vapour deposition, in particular vacuum evaporation deposition, or electroless deposition, preferably by vacuum evaporation deposition.

Vacuum evaporation deposition typically comprises heating a metal source such as a lithium source above its melting temperature in a vacuum chamber thereby providing evaporated metal particles which then typically condense to a solid state onto a substrate.

Electroless deposition is typically carried out in a plating bath wherein a lithium cation of a lithium salt is reduced from its oxidation state to its elemental state in the presence of suitable chemical reducing agents.

Under step (iii-3) of the process for manufacturing an electrode according to the third embodiment of the invention, at least one metal layer may be applied onto the at least one lithium layer provided in step (ii-3) by any suitable techniques such as lamination.

Lamination typically comprises stacking the layers thereby providing an assembly and, optionally, pressing the assembly so obtained at a temperature comprised between 20° C. and 120° C.

For the purpose of the present invention, the term “separator” is intended to denote a film which is capable of physically and electrically separating the anode from the cathode of the electrochemical cell, while permitting electrolyte ions to flow there through.

The separator (c) of the secondary battery of the invention is typically adhered between the film of the electrode (a) and the positive electrode ( b).

The separator (c) of the secondary battery of the invention is typically a porous separator.

The separator (c) of the secondary battery of the invention is typically made from a polyolefin, preferably made from polyethylene or polypropylene.

The secondary battery of the invention is typically filled with an electrolyte medium [medium (E)].

The medium (E) typically comprises a metal salt. The metal salt is typically selected from the group consisting of Mel, Me(PF₆)ₙ, Me(BF₄)ₙ, Me(ClO₄)ₙ, Me(bis(oxalato)borate)ₙ (“Me(BOB)ₙ”), MeCF₃SO₃, Me[N(CF₃SO₂)₂]ₙ, Me[N(C₂F₅SO₂)₂]ₙ, Me[N(CF₃SO₂)(R_{F}SO₂)]ₙ with R_{F} being C₂F₅, C₄F₉, CF₃OCF₂CF₂, Me(AsF₆)ₙ, Me[C(CF₃SO₂)₃]ₙ, Me₂S, wherein Me is a metal, preferably a transition metal, an alkaline metal or an alkaline-earth metal, more preferably Me being Li, Na, K, Cs, and n is the valence of said metal, typically n being 1 or 2.

The metal salt is preferably selected from the group consisting of LiI, LiPF₆, LiBF₄, LiClO₄, lithium bis(oxalato)borate (“LiBOB”), LiCF₃SO₃, LiN(CF₃SO₂)₂, LiN(C₂F₅SO₂)₂, M[N(CF₃SO₂)(R_{F}SO₂)]ₙ with R_{F} being C₂F₅, C₄F₉, CF₃OCF₂CF₂, LiAsF₆, LiC(CF₃SO₂)₃, Li₂Sₙ and combinations thereof.

The medium (E) typically further comprises at least one organic solvent selected from the group consisting of alkyl carbonates, alkyl ethers, sulfones, ionic liquids, fluorinated alkyl carbonates and fluorinated alkyl ethers.

According to an embodiment of the invention, the medium (E) may further comprise at least one polysulphide of formula Li₂S, wherein n is equal to 1 or higher than 1, preferably n being comprised between 1 and 12.

The Applicant thinks, without this limiting the scope of the invention, that, during operation of a secondary battery in either charge cycles or discharge cycles, due to the presence in the electrolyte medium [medium (E)] of at least one polysulphide of formula Li₂S, wherein n is equal to 1 or higher than 1, preferably n being comprised between 1 and 12, a sulphur layer is advantageously deposited onto the positive electrode of said secondary battery, typically onto at least one carbon layer of the positive electrode of said secondary battery.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

Manufacture of Polymer (F-1)

(A) Manufacture of Polymer Precursor in —SO₂F Form.

In a 22 litre autoclave the following reagents were charged: 11.5 litre of demineralized water, 980 g of CF₂═CF—O—CF₂CF₂—SO₂F and 3100 g of a 5% by weight water solution of CF₂ClO(CF₂CF(CF₃)O)ₙ(CF₂O)ₘCF₂COOK (average molecular weight: 521; ratio n/m: 10).

The autoclave, stirred at 470 rpm, was heated to a temperature of 60° C. and then 150 ml of a water solution containing 6 g/litre of potassium persulphate was added. The pressure was maintained at a value of 12 absolute bar by introducing tetrafluoroethylene (TFE).

After the addition of 1200 g of TFE in the reactor, 220 g of CF₂═CF—O—CF₂CF₂—SO₂F were added every 200 g of TFE fed to the autoclave. The stirring was stopped after 284 min, the autoclave was cooled and the internal pressure was reduced by venting the TFE: a total amount of 4000 g of TFE were fed.

A latex with a concentration of 28% by weight was obtained.

A portion of the latex was then coagulated by freezing and thawing and the recovered polymer was washed with water and dried for 40 hours at 150° C.

The remaining amount of latex was kept under nitrogen bubbling for 16 hours to strip away residual monomers from the polymerization and then frozen in a plastic tank for 48 hours. After evaporation of the water, the coagulated polymer precursor was washed several times with demineralized water and dried in oven at 80° C. for 48 hours thereby obtaining a dry powder.

The polymer was then treated with a mixture of nitrogen and fluorine gas (50/50) in a Monet reactor at 80° C. and ambient pressure for 10 hours with a gas flow of 5 Nl/hour, and then dried in a ventilated oven at 80° C. for 24 hours.

The same procedure can be used to prepare polymer precursors in —SO₂F form having different equivalent weights by varying the reactants feeding ratios.

(B) Manufacture of Polymer in —SO₃Li Form

The polymer precursor in —SO₂F form so obtained was treated for 10 hours with a NaOH solution (10% by weight of NaOH, 10 litre of solution per Kg of polymer) at 80° C. and then washed several times with demineralized water until the pH of the water was less than 9. The polymer was then treated with HNO₃ (20% by weight) in order to obtain complete exchange to —SO₃H form. The polymer was rinsed with water and dried in ventilated oven at 80° C. for 20 hours.

An excess amount of Li₂CO₃ was then added to the aqueous dispersion under stirring at ambient temperature in order to convert all the —SO₃H groups into —SO₃Li form; evolution of CO₂ bubbles was noticed. The polymer powder was then rinsed with water and dried in ventilated oven at 80° C. for 20 hours.

Determination of the Equivalent Weight of Polymer (F-1)

A film was prepared from a sample of dry polymer obtained following procedure (A) as detailed hereinabove by heating the powder in a press at 270° C. for 5 min. A film sample (10 cm×10 cm) was cut and treated with a 10% by weight KOH solution in water for 24 hours at 80° C. and then, after washing with pure water, with a 20% by weight HNO₃ solution at ambient temperature. The film was finally washed with water. Using this procedure the functional groups of the polymer were converted from the —SO₂F form to —SO₃H form.

After drying in vacuum at 150° C., the film was titrated with a standard NaOH solution (e.g. NaOH 0.1 N).

### EXAMPLE 1

A solution containing 5% by weight of polymer (F-1) having an equivalent weight of 660 g/eq in propylene carbonate was prepared after 4 hours under stirring at 80° C. The solution so obtained was clear and homogeneous.

### EXAMPLE 2

A solution containing 10% by weight of polymer (F-1) having an equivalent weight of 870 g/eq in propylene carbonate was prepared after 4 hours under stirring at 80° C. The solution so obtained was clear and homogeneous.

### COMPARATIVE EXAMPLE 1

The same procedure as detailed under Example 1 was followed but using dimethyl sulphoxide.

### COMPARATIVE EXAMPLE 2

The same procedure as detailed under Example 1 was followed but using N-methyl-2-pyrrolidone.

### EXAMPLE 3

### Manufacture of a Film

A film having a thickness of 20 μm was manufactured using the solution prepared according to Example 1 by tape casting and drying (48 hours under vacuum at 120° C.).

### EXAMPLE 4

### Manufacture of a Negative Electrode

A lithium electrode was prepared using a current collector comprising a lithium foil which was cut in the desired dimensions. The solution prepared according to Example 1 was then coated by doctor blade technique onto the lithium foil of the current collector and then dried at 60° C. (firstly under argon, then under vacuum) thereby providing a protective layer having a final thickness of about 30 μm. The assembly so obtained was cut thereby providing a negative electrode comprising a lithium layer having a diameter of 14 mm and, adhered to said lithium layer, a protective film having a diameter of 16 mm.

### EXAMPLE 5

### Manufacture of a Negative Electrode

The film prepared according to Example 3 was dried under vacuum to remove water traces. Lithium metal deposition with thicknesses up to about 1 μm was performed on the film by vacuum evaporation technique. The lithium/protective film stack was then cut into a lithium electrode.

### COMPARATIVE EXAMPLE 3

The same procedure as detailed under Example 4 was followed but using the solution prepared according to Comparative Example 1.

### COMPARATIVE EXAMPLE 4

The same procedure as detailed under Example 4 was followed but using the solution prepared according to Comparative Example 2.

Manufacture of a Sulphur Positive Electrode

A sulphur cathode was prepared by mixing carbon black powder (10% by weight), sulphur powder (80% by weight) and a polyvinylidene fluoride binder (10% by weight) in N-methyl-2-pyrrolidone. The slurry was then coated onto an aluminium foil of 20 μm to a thickness of 100 μm. After drying at 55° C., the thickness of the electrode was about 15 μm, with a loading of sulphur of about 1.8 mg/cm².

### EXAMPLE 6

### Manufacture of a Li—S Battery

A coin cell was assembled under controlled atmosphere in a glove box. The lithium electrode prepared according to Example 4 was cut into a 14 mm disk and then dried under vacuum. An assembly was prepared using a CR2032 coin cell casing, said assembly comprising, in succession, a sulphur positive electrode having a diameter of 14 mm, a porous separator made of polypropylene having a diameter of 16.5 mm and the negative electrode prepared according to Example 4. An electrolyte medium containing lithium bis(trifluoromethanesulfonyl)imide (LiTFSI) 1M in tetraethylene glycol dimethyl ether (TEGDME)/1,3-dioxolane (DIOX) (50/50 by volume) was impregnated into the cell so obtained. The cell was then sealed in the glove box and then cycled between 1.5 V and 3 V vs. Li+/Li at C/10.

### EXAMPLE 7

### Manufacture of a Li—S Battery

A coin cell was assembled under controlled atmosphere in a glove box. The film prepared according to Example 3 was cut into a 16.5 mm disk and then dried under vacuum. An assembly was prepared using a CR2032 coin cell casing, said assembly comprising, in succession, a sulphur positive electrode having a diameter of 14 mm, a porous separator made of polypropylene having a diameter of 16.5 mm, the film prepared according to Example 3 having a diameter of 16.5 mm and a lithium electrode having a diameter of 16 mm. An electrolyte medium containing lithium bis(trifluoromethanesulfonyl)imide (LiTFSI) 1M in tetraethylene glycol dimethyl ether (TEGDME)/1,3-dioxolane (DIOX) (50/50 by volume) was impregnated into the cell so obtained. The cell was then sealed in the glove box and then cycled between 1.5 V and 3 V vs. Li+/Li at C/10.

### COMPARATIVE EXAMPLE 5

A mixture comprising 10.4% by weight of polymer (F-1) having an equivalent weight of 790, 75.0% by weight of water and 14.6% by weight of n-propanol was prepared and subsequently dropped onto a circular sample of porous separator made of polypropylene (weight: 170 mg, area: 95 cm², thickness: 30 μm) at room temperature. The wet separator so obtained was then dried in an oven using the following temperature program: 1.5 hours at 65° C., 1.5 hours at 90° C. and 15 minutes at 160° C. After drying, the weight increase and the SEM analysis confirmed the presence of a dense and homogeneous polymer film covering the pores initially present on the polypropylene support (0.25 mg/cm² on each side). An assembly was prepared using a CR2032 coin cell casing, said assembly comprising, in succession, a sulphur positive electrode having a diameter of 14 mm, the separator so obtained having a diameter of 16.5 mm and a lithium electrode having a diameter of 16 mm. An electrolyte medium containing lithium bis(trifluoromethanesulfonyl)imide (LiTFSI) 1M in tetraethylene glycol dimethyl ether (TEGDME)/1,3-dioxolane (DIOX) (50/50 by volume) was impregnated into the cell so obtained. The cell was then sealed in the glove box and then cycled between 1.5 V and 3 V vs. Li+/Li at C/10.

### COMPARATIVE EXAMPLE 6

A coin cell was assembled under controlled atmosphere in a glove box. An assembly was prepared using a CR2032 coin cell casing, said assembly comprising, in succession, a sulphur positive electrode having a diameter of 14 mm, a porous separator made of polypropylene having a diameter of 16.5 mm and a lithium electrode having a diameter of 16 mm. An electrolyte medium containing lithium bis(trifluoromethanesulfonyl)imide (LiTFSI) 1M in tetraethylene glycol dimethyl ether (TEGDME)/1,3-dioxolane (DIOX) (50/50 by volume) was impregnated into the cell so obtained. The cell was then sealed in the glove box and then cycled between 1.5 V and 3 V vs. Li+/Li at C/10.

### COMPARATIVE EXAMPLE 7

A Li/S cell was prepared following the same procedure as detailed under Example 6 but using the lithium electrode prepared according to Comparative Example 3.

### COMPARATIVE EXAMPLE 8

A Li/S cell was prepared following the same procedure as detailed under Example 6 but using the lithium electrode prepared according to Comparative Example 4.

Electrochemical Measurements

Electrochemical measurements were performed in CR2032 coin cells at room temperature and C/100 between 1.5V and 3V.

The results are set forth in Table 1 here below.

Data reported in Table 1 represent average values of two cell test measurements carried out in parallel.

The specific discharge capacity values [mAh/g of S] are representative of the percentage of sulphur utilization in the Li—S coin cells.

The capacity retention values [%] are representative of the retention of the initial specific discharge capacity values upon charge/discharge cycles of the Li—S coin cells. The higher the capacity retention values, the better the cycle life of the cell.

The columbic efficiency values [%] are representative of the fraction of the electrical charge stored during charging that is recoverable during discharge.

TABLE 1

| | | | | | C. | C. |
|---|---|---|---|---|---|---|
| Run | | Ex. 7 | C. Ex. 5 | C. Ex. 6 | Ex. 7 | Ex. 8 |
| Specific | Cycle 1 | 1050 | 806 | 780 | 715 | 790 |
| Discharge | | | | | | |
| Capacity at C/100 | | | | | | |
| [mAh/g] | | | | | | |
| Capacity | Cycle 2 | 64 | 66 | — | — | — |
| retention at 20° C. | Cycle 25 | 51 | — | — | — | — |
| and C/100 [%] | Cycle 50 | 40 | — | — | — | — |
| Columbic | Cycle 2 | 96 | <50 | — | — | — |
| Efficiency at 20° C. | Cycle 25 | 88 | — | — | — | — |
| and C/100 [%] | Cycle 50 | 89 | — | — | — | — |

The runs corresponding to the electrochemical measurements of the Li—S coin cells of Comparative Examples 6, 7 and 8 were stopped after the first cycle due to polysulphide shuttle mechanism. Also, the run corresponding to the electrochemical measurements of the Li—S coin cell of Comparative Example 5 was stopped after the second cycle due to polysulphide shuttle mechanism.

As shown by the charge/discharge curves of the Li—S coin cells of Comparative Examples 5, 6, 7 and 8, an infinite charging threshold was registered leading to reduced columbic efficiency of the cell.

In contrast, good capacity retention and columbic efficiency (after at least up to 50 cycles) were observed during the electrochemical measurements of the Li—S batteries of the present invention as notably embodied by the Li—S coin cells of Examples 6 and 7 according to the invention. Without wishing to be bound by theory, this indicates an absent or very reduced polysulphide shuttle mechanism in the cells according to the invention.

Moreover, as shown in Table 1 here above, the Li—S coin cells of Example 7 according to the invention successfully exhibited both higher specific discharge capacity values and higher columbic efficiency values as compared to conventional Li—S batteries as notably embodied by any of the Li—S coin cells of Comparative Examples 5, 6, 7 and 8.

Further, as shown in Table 1 here above, the Li—S coin cells of Example 7 according to the invention successfully exhibited good or higher capacity retention values as compared to conventional Li—S batteries as notably embodied by the Li—S coin cell of Comparative Example 5.

In view of all the above, it has been thus found that the Li—S battery of the invention successfully exhibited absent or reduced polysulphide shuttle mechanism, while maintaining good or increased capacity values, as compared to conventional Li—S batteries.

1. A process for manufacturing a film, said process comprising:
processing a composition (C) into a film, said composition (C) comprising:
at least one fluoropolymer [polymer (F)] comprising recurring units derived from at least one fluorinated monomer comprising a —SO₃M functional group, wherein M is an alkaline metal [monomer (FM)] and
a liquid medium (L) comprising at least 50% by weight, based on the total weight of said medium (L), of at least one alkyl carbonate; and
drying the film.

2. The process according to claim 1, wherein the composition (C) is in the form of a solution.

3. The process according to claim 1, wherein the polymer (F) comprises recurring units derived from:
at least one monomer (FM) selected from the group consisting of fluorovinylethers of formula CF₂═CF—O—(CF₂)ₘ—SO₃Li, wherein m is an integer comprised between 1 and 6, and
tetrafluoroethylene.

4. The process according to claim 1, wherein the alkyl carbonate is selected from the group consisting of linear alkyl carbonates of formula (I) and cyclic alkylene carbonates of formula (II): 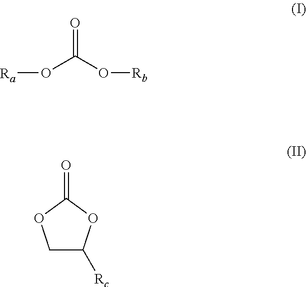
wherein:
Rₐ and R_{b}, equal to or different from each other, are independently C₁-C₆ alkyl groups, and
R_{c} is a hydrogen atom or a C₁-C₆ alkyl group.

5. The process according to claim 1, wherein medium (L) further comprises at least one alkyl ether.

6. A film obtained by the process according to claim 1.

7. The film according to claim 6, said film comprising at least one layer comprising at least one fluoropolymer [polymer (F)] comprising recurring units derived from at least one fluorinated monomer comprising a —SO₃M functional group, wherein M is an alkaline metal [monomer (FM)].

8. An electrode comprising a current collector, said current collector comprising:
at least one lithium layer, and
adhered to said at least one lithium layer, the film according to claim 6.

9. A process for manufacturing the electrode according to claim 8, said process comprising:
applying a composition (C) onto the at least one lithium layer of a current collector comprising at least one lithium layer, said composition (C) comprising:
at least one fluoropolymer [polymer (F)] comprising recurring units derived from at least one fluorinated monomer comprising a —SO₃M functional group, wherein M is an alkaline metal [monomer (FM)] and
a liquid medium (L) comprising at least 50% by weight, based on the total weight of said medium (L), of at least one alkyl carbonate; and
drying the film.

10. A process for manufacturing the electrode according to claim 8, said process comprising:
applying a film onto the at least one lithium layer of a current collector comprising at least one lithium layer, said film being obtained by a process comprising:
processing a composition (C) into a film, said composition (C) comprising:
at least one fluoropolymer [polymer (F)] comprising recurring units derived from at least one fluorinated monomer comprising a —SO₃M functional group, wherein M is an alkaline metal [monomer (FM)] and
a liquid medium (L) comprising at least 50% by weight, based on the total weight of said medium (L), of at least one alkyl carbonate;
drying the film.

11. A process for manufacturing the electrode according to claim 8, said process comprising:
depositing at least one lithium layer onto a film, said film being obtainable by a process comprising:
processing a composition (C) into a film, said composition (C) comprising:
at least one fluoropolymer [polymer (F)] comprising recurring units derived from at least one fluorinated monomer comprising a —SO₃M functional group, wherein M is an alkaline metal [monomer (FM)] and
a liquid medium (L) comprising at least 50% by weight, based on the total weight of said medium (L), of at least one alkyl carbonate; and
drying the film
said film having an inner surface and an outer surface; and
optionally, applying at least one metal layer onto the at least one lithium layer.

12. A secondary battery comprising:
(a) an electrode comprising a current collector, said current collector comprising:
at least one lithium layer, and
adhered to said at least one lithium layer, the film according to claim 6,
(b) a positive electrode, and
(c) a separator.

13. The secondary battery according to claim 12, wherein the separator (c) is adhered between the film of the electrode (a) and the positive electrode (b).

14. The secondary battery according to claim 12, said secondary battery being a lithium-sulphur (Li—S) battery wherein the positive electrode (b) comprises a current collector, said current collector comprising at least one sulphur layer.

15. The Li—S battery according to claim 14, wherein the positive electrode (b) comprises a current collector, said current collector comprising:
at least one carbon layer, and
adhered to said at least one carbon layer, at least one sulphur layer.

16. The process according to claim 3, wherein m is an integer comprised between 2 and 4.

17. The process according to claim 4, wherein:
Rₐ and R_{b}, equal to or different from each other, are independently C₁-C₄ alkyl groups, and
R_{c} is a hydrogen atom or a C₁-C₄ alkyl group.

18. The process according to claim 17, wherein:
Rₐ and R_{b}, equal to or different from each other, are independently C₁-C₂ alkyl groups, and
R_{c} is a hydrogen atom or a C₁-C₂ alkyl group.
